(19) United States
(12) Patent Application Publication
(10) Pub. No.: US 2026/0221836 A1
(43) Pub. Date: Jul. 30, 2026

(54) ELECTRIC DRIVE FOR AN ELECTRICALLY DRIVEN VEHICLE

(71) Applicant: Robert Bosch GmbH, Stuttgart (DE)

(72) Inventors: Michael Wolfgang Goerdeler, Boeblingen (DE); Szilard Szabo, Budapest (HU); Tim Kanzleiter, Bad Boll (DE)

(21) Appl. No.: 19/141,777

(22) PCT Filed: Nov. 29, 2023
(86) PCT No.: PCT/EP2023/083459

§ 371 Date: Jul. 23, 2025

(30) Foreign Application Priority Data
Dec. 21, 2022 (DE) 10 2022 214 140.7

(51) Int. Cl. H02K 5/20; H02K 9/19

(52) U.S. Cl. CPC H02K 5/203; H02K 9/19

(57) ABSTRACT

The invention relates to an electric drive (1) for an electrically driven vehicle. The electric drive is equipped with a system housing (2), which has a stator receiving region (3); a stator (4), which is arranged in the stator receiving region (3), and a stator housing (5), which supports and at least partially surrounds the stator (4), wherein the stator housing (5) has a spirally arranged fin device (7) on its outer wall (6) for guiding a cooling medium in an intermediate space (8) between the system housing (2) and the stator housing (4).

### BACKGROUND

The present invention relates to an electric drive for an electrically driven vehicle.

In electric machines used in electric drive axles of electric vehicles, their stator is typically cooled with liquid. To this end, the stator is often installed in an aluminum housing manufactured by a die cast process. The housing is typically double-walled and has a cooling channel between the two walls through which the cooling liquid can flow. This ensures a continuous flow around the electrical machine and thus cools it.

Since, for manufacturing reasons, the raw casting of the component forming the external design of the cooling channel has a demolding slope of approximately 1.5°, the disadvantage of the prior art is that significantly higher amounts of material must be removed by machining to a diameter. This leads to additional costs and also increases the risk of leakage for components manufactured in the die-casting process. In addition, when mounting the two housing parts that form the cooling channel, there is a risk of the two parts colliding if a small gap between both the two components is aimed for.

For example, DE 10 2020 201 127 A1 describes an electric drive of an electrically driven vehicle having a rotor and a stator surrounded by a housing. The housing comprises an outer part and an inner part each having an axial fin extending in the axial direction of the housing.

DE 10 2015 221 776 A1 further describes a housing arrangement, wherein an outer cooling jacket surface of the cooling jacket is formed by the inner wall of the stator receiving region and this inner wall is conical or stepped cylindrical in shape.

### SUMMARY

The invention provides an electric drive for an electrically driven vehicle having the features of the disclosure.

According to a first aspect of the invention, an electric drive for an electrically driven vehicle is provided. The electric drive comprises a system housing having a stator receiving region and a stator arranged in the stator receiving region. Further, the electric drive comprises a stator housing which supports and at least partially surrounds the stator. On its outer wall, the stator housing contains a spirally arranged fin device for guiding a cooling medium in an intermediate space between the system housing and the stator housing.

One idea underlying the present invention is to provide a narrow sealing gap between the fin device and the system housing so that the cooling medium flows more evenly through the intermediate space/cooling channel. This is followed by a more even cooling output of the electric drive during operation. Furthermore, a more homogeneous cooling is made possible over the entire jacket surface of the stator housing. In addition, self-venting of the system housing is improved.

Self-venting allows any air introduced during filling or refilling of the intermediate space to be conveyed out of the intermediate space again by a continuous, relatively high flow rate of the cooling medium with the flow of the cooling medium. Advantageously, the air introduced cannot therefore remain in the intermediate space for an indefinite period of time and thus possibly only enters a cooling system in an uncontrolled manner at a later time.

Further, machining of the system housing following a die-casting process is reduced because a contour of the fin device can be adapted to the shape of the stator receiving region. By minimizing the necessary machining of the system housing in the stator receiving region, the risk of leakage of the cooling channel can be reduced.

Advantageous embodiments and developments emerge from the further dependent claims and from the description with reference to the figures of the drawing.

According to a further development of the electric drive, an inner wall of the stator housing is cylindrical. In this way, the stator may be completely cylindrical in shape in order to be mounted in the stator housing. Consequently, the stator does not have to be stamped in multiple layers from a plurality of stator laminations of different diameters. This simplifies the design of the stator and reduces manufacturing costs.

According to another further development of the electric drive, the stator receiving region of the system housing is conical or stepped cylindrical in shape. In particular, an inner wall of the stator receiving region is conical or stepped cylindrical in shape. Alternatively, the stator receiving region or the inner wall can be conical and stepped cylindrical in shape. For example, conical in a front section, wherein the stator receiving region may change into a stepped cylindrical section.

During the joining process of the stator, i.e. during the axial displacement of the stator relative to a rotor that is surrounded by the stator, a collision may occur between a contour of the stator housing and a contour of the stator receiving region. This risk exists in particular when two cylindrical parts are joined. The conical or stepped cylindrical design of the stator receiving region can therefore facilitate the joining process, as a gap between the fin device and the system housing only narrows at the end of the joining process. As a result, there is a relatively large gap at the start of the joining process, which minimizes the risk of collision. Although an additional machining step is necessary in this way, less material is machined during reworking of the stator receiving region of the system housing following the die-casting process than during reworking to a constant diameter over the entire length of the stator receiving region, i.e. to a cylindrical shape of the stator receiving region, in particular to a cylindrical shape of the inner wall.

According to a further development of the electric drive, the individual steps of the stator receiving region, which is designed as a stepped cylinder, have a radial jump on an inner wall of the system housing of at most about 2 mm. Preferably, the individual steps of the stator receiving region, which is designed as a stepped cylinder, have a radial jump on an inner wall of the system housing of at most about 0.8 mm. This further reduces the need for post-machining of the system housing.

According to another further development of the electric drive, the conicity of an envelope of the fin device essentially corresponds to a conicity of the stator receiving region. The envelope denotes a fictitious jacket surface which forms the fin device in a conceptual approximation, whereby the envelope is tangent to the tips of the fin device. In particular, the envelope of the fin device corresponds substantially to a conicity of the inner wall of the stator receiving region. Thus, the sealing gap between the fin device and the system housing may be kept low, allowing the cooling medium to flow more evenly through the intermediate space.

According to another further development of the electric drive, the fin device has a slope in the range of about 5 mm to about 50 mm in an axial direction of the stator housing. In particular, the fin device has a slope in the range of about 10 mm to about 35 mm in an axial direction of the stator housing. Optionally, the slope of the fin device may vary along the axial direction. For example, the slope of the fin device can be lower in a section of the stator housing in which the fin device is deeper when viewed in a radial direction than in a section of the stator housing in which the fin device is flatter when viewed in a radial direction. This means that a cross-sectional area of the cooling channel can be substantially constant over the entire intermediate space by adjusting the slope in the axial direction to a height of the fin device, whereby the product of slope and height can be substantially constant. Likewise, the cross-sectional area may also be increased or decreased by the varying slope, for example to lower or increase a flow rate of the cooling medium.

Alternatively or additionally, the fin device can have an average width in the range of about 2 mm to about 12 mm when viewed in cross-section. In particular, the fin device can have an average width in the range of about 3 mm to about 10 mm when viewed in cross-section. That is to say, the average width represents an extension of the fin device in the axial direction of the stator housing, wherein the average width is given at approximately half the height of the fin device.

According to a further development of the electric drive, the fin device of the stator housing mounted in the stator receiving region has a sealing gap of at most about 0.4 mm in a radial direction of the stator housing relative to the system housing. Preferably, the fin device of the stator housing mounted in the stator receiving region has a sealing gap of at most about 0.30 mm in a radial direction of the stator housing relative to the system housing. The risk of a double fit can thus be reduced because the fin device should not come into contact with the system housing, wherein the sealing gap in the radial direction is sufficiently small to substantially prevent a cooling medium flow via the tips of the fin device. Consequently, the guiding of the cooling medium in the intermediate space may be improved. In particular, the sealing gap corresponds to a sealing gap that is aimed for between the system housing and the stator housing in order to ensure reliable guidance of the cooling medium.

According to a further development of the electric drive, the stator housing comprises a cylindrical base body, in particular a hollow cylindrical base body, with an outer diameter in the range of about 100 mm to about 350 mm. In particular, the stator housing comprises a cylindrical base body, in particular a hollow cylindrical base body, with an outer diameter in the range of about 150 mm to about 300 mm.

According to a further development of the electric drive, the fin device has a height in the range of about 3 mm to about 20 mm in a radial direction of the stator housing with respect to a cylindrical base body of the stator housing. That is to say, the height represents an extension of the fin device in the radial direction starting from the cylindrical base body of the stator housing. Preferably, the fin device has a height in the range of about 5 mm to about 15 mm relative to a cylindrical base body of the stator housing in a radial direction of the stator housing.

According to another further development of the electric drive, the spirally arranged fin device is configured with one or two parts. Several independent, parallel cooling channels can be provided, particularly in the case of a two-part fin device arrangement. The advantage of the two-part fin device arrangement is that in the event of problems in a first cooling channel, the second cooling channel provides at least one minimum level of cooling, as the second cooling channel is not affected by a blockage in the first cooling channel, for example, and cooling medium can continue to flow. Optionally, the cooling medium flow in one of the plurality of cooling channels may be controlled via a control unit.

### BRIEF DESCRIPTION OF THE DRAWINGS

The invention is explained below with reference to the figures of the drawings. The drawings show:

FIG. 1 a schematic cross-sectional diagram of a stator receiving region and a stator housing mounted therein in accordance with an exemplary embodiment of the invention;

FIG. 2 a schematic side view of an electric drive at the start of a joining process in which a stator and a rotor are joined according to a further embodiment of the invention;

FIG. 3 a schematic side view of the electric drive of FIG. 2 at the end of the joining process, with an intermediate space formed for a cooling medium.

### DETAILED DESCRIPTION

In the drawings, identical reference numerals denote identical or functionally identical components, unless stated otherwise.

A slope of the fin device within the meaning of this application refers to the distance along the axial direction that the fin device travels during one revolution. This corresponds to the distance between two tips of the fin device in the axial direction.

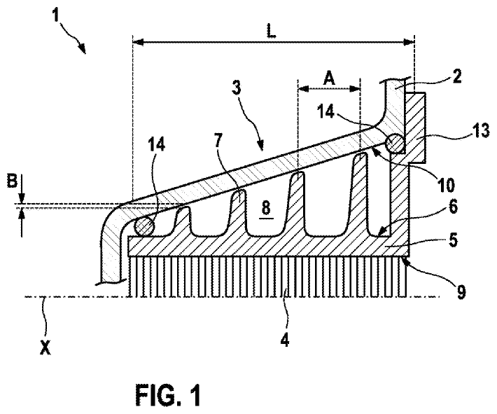

A tip or head of the fin device in the sense of this application refers to the furthest point in the radial direction with reference to an axis of rotation of the stator housing in the longitudinal section of the stator housing (as also shown in FIGS. 1 to 3). The longitudinal section of the stator housing corresponds to the cross-section of the fin device. The tip/head respectively refers to a specific point of the fin device as it is in a specific longitudinal section, such that the fin device comprises a plurality of infinitesimally small tips along its spiral extension.

In particular, a radial jump of the slope of the fin device corresponds to the tangent of the deformation slope of the stator receiving area, wherein the deformation slope is indicated in degrees, i.e., °. Accordingly, with an increasing slope of the fin device, there is also a greater radial jump.

FIG. 1 shows a schematic cross-sectional diagram of a stator receiving region 3 and a stator housing 5 mounted therein or inserted therein.

The stator receiving region 3 of a system housing 2 and the stator housing 5 are part of an electric drive 1 for an electrically driven vehicle. The stator receiving region 3 of the system housing 2 is conical in FIG. 1 as an example. The stator receiving region 3 preferably has a substantially constant wall thickness of the system housing 2, but is not limited to this.

Alternatively, the wall thickness may vary. An intermediate space 8 is formed between the system housing 2 and the stator housing 5. A cooling medium, in particular a cooling liquid, can flow in the intermediate space 8. The stator housing 5 or its inner wall 9 is preferably cylindrical.

Further, the electric drive 1 includes a stator 4. The stator 4 is formed from a plurality of individual stator laminations, which are stacked or combined to form a so-called stator lamination core. The stator 4 or the stator lamination core is arranged in the stator housing 5, the outer circumferential surface/outer wall 6 of which simultaneously forms an inner cooling jacket surface of the intermediate space 8 and which seals the intermediate space 8 on the stator side or (radially) inwards. The stator housing 5 is mounted together with the stator 4 received therein from the right according to the illustration in FIG. 1. Due to the conical formation of an inner wall of the stator receiving region 3, the mounting opening or the opening cross-section of the stator receiving region 3 is larger than a bottom surface at the other axial end of the stator receiving region 3. The torque support of the stator housing 5 in relation to the system housing 2 can be effected with the aid of a cover 13, which is screwed or welded to the system housing 2, for example. By way of example, the cover 13 is formed integrally with the stator housing 5. In addition, the cover 13 closes the intermediate space 8 in an axial direction X on an opening side of the stator receiving region 3. Sealing between the stator housing 5 or its outer wall 6, the cover 13 and the stator receiving region 3 on the system housing side or its inner wall 10 is achieved by two elastic seals 14, which are preferably formed as sealing rings.

In addition, a fin device 7 is provided in a spiral arrangement on the outer wall 6 of the stator housing 5. In FIG. 1, the fin device 7 comprises an exemplary fin. That is to say, the fin device 7 has one part. The spiral shape extends around the axial direction X of the stator housing 5 so that the spirally arranged fin is aligned comparable to a thread. The fin 7 of the stator housing 5 projects in a radial direction from the outer wall 6 of the stator housing 5 as shown in FIG. 1. The fin 7 thus forms at least one cooling channel in the intermediate space 8 through which the cooling medium can flow. Further, the fin 7 projects in the radial direction from the outer wall 6 to the inner wall 10, wherein the radial extension becomes smaller the further the cone of the stator receiving region 3 tapers from the opening side towards the bottom surface due to the conical design of the stator receiving region 3 in combination with the cylindrical design of the stator housing 5. Accordingly, the radial extension of the fin 7 according to FIG. 1 decreases from right to left. Tips/heads of the fin 7 can be joined to form an envelope. The envelope of the fin 7 corresponds in its conicity substantially with a conicity of the stator receiving region 3.

For example, the fin 7 has a slope A of about 21 mm relative to the neighboring tip of the fin 7 along the axial direction X. Furthermore, the fin 7 has a sealing gap B of at most 0.4 mm in the radial direction of the stator housing 5 in relation to the system housing 2.

Optionally, the fin 7 can comprise a plurality of fin sections that are configured differently from one another. For example, the fin 7 may be partially or completely discontinuous. Furthermore, the fin 7 can also be combined with a fin of a different orientation, i.e., a non-spiral arrangement.

Furthermore, an inlet opening for the inflow of the cooling medium into the intermediate space 8 is arranged at one axial end of the stator receiving region 3 and an outlet opening for the outflow of the cooling medium is arranged at the other axial end of the stator receiving region 3. This means the inlet opening and the outlet opening are exemplary provided at axially opposite ends of the intermediate space 8. In the radial direction and a circumferential direction, the arrangement of the inlet opening and the outlet opening may be substantially freely selected.

Advantageously, self-venting can be present. On the one hand, self-venting may be provided by gravity, i.e. the inlet opening is provided at the bottom in the direction of gravity in relation to the intermediate space 8, for example, and the outlet opening for the cooling medium is provided at the top in the direction of gravity in relation to the intermediate space 8. In this case, self-venting can also be provided with a sealing gap B of at least 0.3 mm, as the air introduced, driven by gravity, is also conveyed from regions of the intermediate space 8 through which the cooling medium flows at a relatively low flow rate.

Alternatively or additionally, self-venting can be provided by a continuous forced flow of the cooling medium. In this case, there are no weakly flowed-through regions of the intermediate space 8 in which air bubbles could remain. The air introduced by filling or refilling can be conveyed out of the intermediate space within a predetermined time by the flow of the cooling medium. For example, a small sealing gap B may be provided between the stator support 5 and the system housing 2.

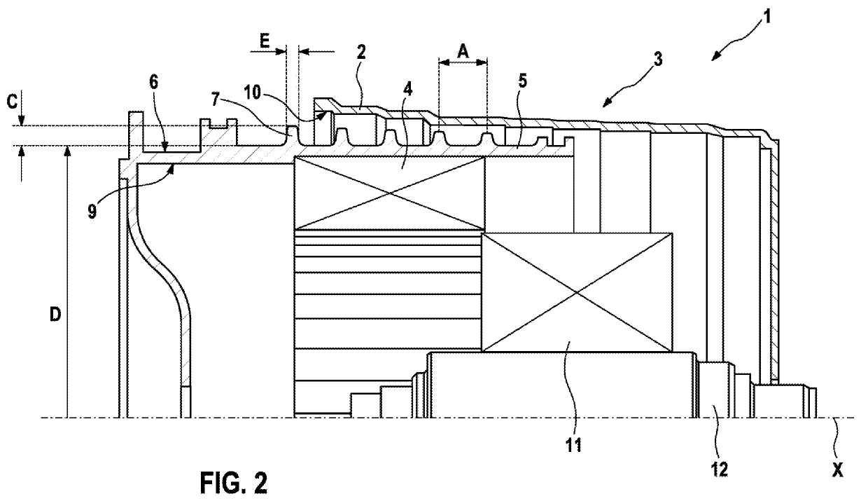

FIG. 2 shows a schematic side view of an electric drive 1 at the start of a joining process in which a stator 4 and a rotor 11 are joined.

The electric drive 1 comprises a system housing 1 having a stator receiving region 3, the stator 4, and a stator housing 5 having a fin device 7. These components essentially have the features described in relation to FIG. 1. However, according to the exemplary embodiment of FIG. 2 of FIG. 1, the electric drive 1 differs in that the system housing 2 has a stepped cylindrical design. In particular, the inner wall 10 of the system housing 2 has a stepped cylindrical design.

In order to produce the stepped cylindrical inner wall 10, the system housing 2 is machined in steps in the stator receiving region 3, wherein the steps follow a stock contour of the molded system housing 2. Thus, it can be ensured that the required machining is minimized. The nominal degree of machining may be determined by the number of steps, which means the more steps provided, the smaller the nominal degree of machining. Preferably, the nominal degree of machining is at most 2 mm.

In the exemplary embodiment according to FIG. 2, the stator housing is configured as a hollow cylindrical base body by way of example. The hollow cylindrical base body has an external diameter D of about 220 mm. In addition, when viewed in cross-section, for example, the fin device can have an average width E of about 8 mm. Preferably, the fin device has a height C in the range of about 5 mm to about 15 mm with respect to the outer wall 6 of the hollow cylindrical base body, wherein the height of the fin device 7 decreases with increasing distance to the opening side of the stator receiving region 3.

Further, the electric drive 1 comprises the rotor 11 mounted on a rotor shaft 12. The electric drive 1 is configured as an electric motor, for example.

The joining process is monitored with a force-path curve. A collision between the joining partners can be read from the force-path curve. However, it is not possible to distinguish between a collision in the region of the active parts of the electric motor 1, i.e., stator 4 and rotor 11, or a collision in the region of the housing parts, i.e., system housing 2 and stator housing 5. In FIG. 2, it can be seen that at the start of the joining process, a gap between the system housing 2 and the stator housing 5 is greater than a gap between the stator 4 and the rotor 11. Thus, the collision between rotor 11 and stator 4 is most likely at the start of the joining process. The gap between the fin device 7 of the stator housing 5 and the inner wall 10 of the stator receiving region 3 decreases during the joining process, wherein this gap at the end of the joining process is smaller than the gap between the active parts, i.e. between the stator 4 and the rotor 11. Advantageously, this can be analyzed as follows. If a collision, as can be read from the force-path curve, occurs at the start of the joining process, it is probably the collision between the stator 4 and the rotor 11, i.e. the active parts. If, on the other hand, a collision, as can be read from the force-path curve, occurs at the end of the joining process, it is probably the collision between the system housing 2 and the stator housing 5.

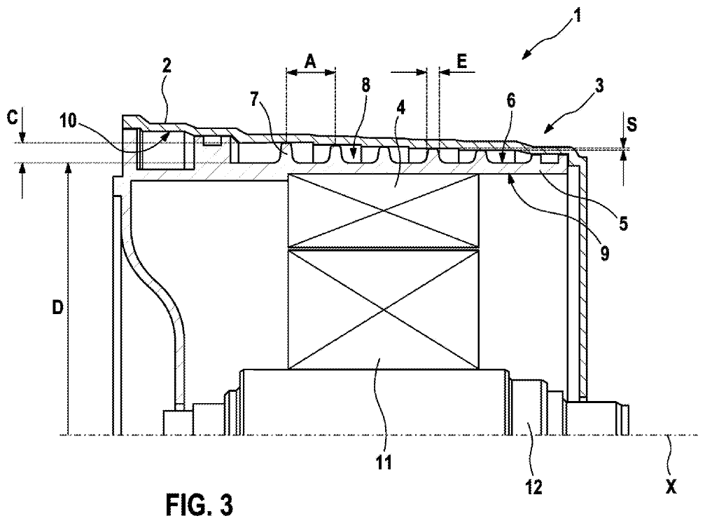

FIG. 3 shows a schematic side view of the electric drive 1 of FIG. 2 at the end of the joining process with a gap 8 formed for a cooling medium.

In FIG. 3, the individual steps of the step cylindrical stator receiving region 3 comprise a radial jump S on the inner wall 10 of the system housing 2, for example. The radial jump S is at most about 0.8 mm.

Although the present invention has been explained hereinabove by way of example with reference to exemplary embodiments, it is not limited thereto and can be modified in many ways. Combinations of the above exemplary embodiments are in particular also conceivable.

1. An electric drive (1) for an electrically driven vehicle, comprising:
a system housing (2) which has a stator receiving region (3);
a stator (4); which is arranged in the stator receiving region (3); and
a stator housing (5), which supports and at least partially surrounds the stator (4), wherein the stator housing (5) has a spirally arranged fin device (7) on its outer wall (6) for guiding a cooling medium in an intermediate space (8) between the system housing (2) and the stator housing (4).

2. The electric drive according to claim 1, wherein an inner wall (9) of the stator housing (5) is cylindrical.

3. The electric drive according to claim 1, wherein the stator receiving region (3) of the system housing (2) is conical or stepped cylindrical.

4. The electric drive according to claim 3, wherein individual steps of the stepped cylindrical stator receiving region (3) comprise a radial jump(S) on an inner wall (10) of the system housing (2) of at most about 2 mm.

5. The electric drive according to claim 3, wherein an envelope of the fin device (7) corresponds in its conicity substantially to a conicity of the stator receiving region (3).

6. The electric drive according to claim 1, wherein the fin device (7) in an axial direction (X) of the stator housing (3) comprises a slope (A) in a range from about 5 mm to about 50 mm.

7. The electric drive according to claim 1, wherein the fin device (7) of the stator housing (5), mounted in the stator receiving region (3) in a radial direction of the stator housing (5) relative to the system housing (2), comprises a sealing gap (B) of at most about 0.4 mm.

8. The electric drive according to claim 1, wherein the stator housing (3) comprises a cylindrical base body having an outer diameter (D) in a range of about 100 mm to about 350 mm. mm.

9. The electric drive according to claim 8, wherein the fin device (7) has a height (C) in a range of about 3 mm to about 20 mm in a radial direction of the stator housing (3) relative to the cylindrical base body of the stator housing (3).

10. The electric drive according to claim 1, wherein the spirally arranged fin device (7) is configured with one or two parts.

11. The electric drive according to claim 4, wherein the radial jump(S) on the inner wall (10) of the system housing (2) is at most about 0.8 mm.

12. The electric drive according to claim 6, wherein the fin device (7) in the axial direction (X) of the stator housing (3) comprises a slope (A) in a range from about 10 mm to about 35 mm.

13. The electric drive according to claim 7, wherein the sealing gap (B) is at most 0.30 mm.

14. The electric drive according to claim 8, wherein the cylindrical base body has an outer diameter (D) in a range of about 150 mm to about 300 mm.

15. The electric drive according to claim 10, wherein the fin device (7) has a height (C) in a range of about 5 mm to about 15 mm in a radial direction of the stator housing (3) relative to the cylindrical base body of the stator housing (3).
